(19) United States
(12) Patent Application Publication
(10) Pub. No.: US 2009/0224109 A1
(43) Pub. Date: Sep. 10, 2009

(54) Articulated Robot

(75) Inventors: Masatsugu Hasunuma, Tochigi (JP); Tadashi Oba, Tochigi (JP); Keiichi Takahashi, Tochigi (JP)

Correspondence Address: CARRIER BLACKMAN AND ASSOCIATES, 43440 WEST TEN MILE ROAD, EATON CENTER, NOVI, MI, 48375, US

(73) Assignee: Honda Motor Co., Ltd., Tokyo (JP)

(21) Appl. No.: 12/380,612

(22) Filed: Mar. 2, 2009

(30) Foreign Application Priority Data
Mar. 4, 2008 (JP) 2008-053162

(51) Int. Cl. F16L 3/00; F16L 3/01

(52) U.S. Cl. 248/52

(57) ABSTRACT

The articulated robot 10 has a sixth articulation 30 that rolls, a welding gun 32 connected to the sixth articulation 30, a cable 44 having one part connected to the welding gun 32, the other part being connected to a first support portion 48, and a flange 42 connected to the welding gun 32 and overhung in the diameter direction on the basis of a roll axis J of the sixth articulation 30. The flange 42 has a second support portion 52, having a larger diameter than a mechanical portion 40 around the roll axis J, for supporting a part of the cable 44. The second support portion 52 supports the cable 44 almost in parallel to the roll axis J. The second support portion 52 is provided at the opposite position of a C-shape member 38 on the basis of the roll axis J.

The present invention claims foreign priority to Japanese patent application No. 2008-053162, filed on Mar. 4, 2008, the contents of which is incorporated herein by reference.

### BACKGROUND OF THE INVENTION

1. Field of the Invention

The present invention relates to an articulated robot, and more particularly to an articulated robot having a work machine connected to a articulation capable of rolling and a cable connected to the work machine.

2. Description of Related Art

In a process for manufacturing large amounts of automobile body, an articulated robot provided with a welding gun at the top is employed. In the welding gun, since a power of large current is required to make the spot welding, electric power is supplied from a transformer.

This power line is adequately thick and difficult to insert into the articulated robot, thus, the power line is disposed outside the articulated robot.

Also, the articulated robot has pluralities of articulations to increase a degree of freedom in the attitude of the welding gun, and particularly there is case where the top articulation has a rolling mechanism.

If the top articulation is rolled, a power line for the welding gun is wound on the top articulation, thus, a considerable margin is needed for the line. However, if an excessive margin is provided, a wasteful slack is produced, whereby there is a risk that the line is caught in the work machine. After all, even if the mechanical rotation angle range of the top articulation is large, the slack of the power line is decreased in operation. Therefore, the angle of roll rotation is limited, whereby the efficiency may be lower.

In view of this problem, Japanese Patent Unexamined Publication JP-A-2001-150382 proposes that the cable is supported by a plurality of swingable clamp members, and the attachment of the clamp members is made in the direction crossing the drive shaft direction of a robot portion, for example.

In the robot as described in the JP-A-2001-150382, the structure of the clamp member is complex, and the cable must be provided with a considerable slack, whereby there is still a risk that the wasteful slack is caught in the work machine.

### SUMMARY OF THE INVENTION

The invention has been achieved in the light of the above-mentioned problems, and it is an object of the invention to provide an articulated robot with a simple constitution in which the cable is considerably prevented from being caught in the work machine.

According to the present invention, there is provided an articulated robot including:

a plurality of articulations comprising at least a primary articulation capable of rolling around a roll axis;

a work machine connected to the primary articulation;

a flange which is provided between the primary articulation and the work machine, and extends in a radial direction of the roll axis of the primary articulation;

a cable having a part connected to the work machine and another part supported on a first support portion of the primary articulation with;

wherein a radial dimension of at least an extending part of the flange is larger than the radial dimension of the work machine, and

the cable is further supported on a second support portion formed on the extending part of the flange at a portion between the work machine and the first support portion of the primary articulation.

Due to thus configured flange, the cable is unlikely to contact the work machine, whereby with a simple constitution, the cable can be considerably prevented from being caught in the work machine or the like.

In this case, the second support portion may support the cable substantially in parallel to the roll axis. Thereby, the cable can be guided in the direction away from the work machine.

The articulated robot may further include a cylindrical body provided between the flange and the primary articulation. A concave portion is formed on an outer circumference of the cylindrical body along with a circumferential direction of the cylindrical body.

Thereby, when the first articulation is rolled, the cable is wound around the concave portion, and can be prevented the cable from moving loosely.

Since the articulated robot according to the invention has the flange connected to the work machine and overhung in the diameter direction on the basis of the roll axis of the primary articulation, the cable is unlikely to contact the work machine, whereby with a simple constitution, the cable can be considerably prevented from being caught in the work machine or the like.

### BRIEF DESCRIPTION OF THE DRAWINGS

FIG. 1 is a perspective view of an articulated robot according to an embodiment of the invention;

FIG. 2 is a perspective view of a top portion of the articulated robot according to this embodiment;

FIG. 3 is a plan view of a flange as seen from the direction of roll axis;

FIG. 4 is a side view of the top portion of the articulated robot according to this embodiment;

FIG. 5 is a side view of the top portion of the articulated robot in a state where the sixth articulation is rotated by 360° in the counterclockwise direction;

FIG. 6 is a plan view of the flange, as seen from the direction of roll axis, in a state where the sixth articulation is rotated by 360° in the clockwise direction;

FIG. 7 is a side view of the top portion of the articulated robot in a state where the welding gun is tilted by 90° plus from the state as shown in FIG. 6;

FIG. 8 is a side view of the top portion of the articulated robot in a state where the welding gun is tilted by 90° minus from the state as shown in FIG. 6; and

FIG. 9 is a side view of the top portion of the articulated robot in a state where the welding gun is tilted by 100° plus from the state as shown in FIG. 4.

### DETAILED DESCRIPTION OF EXEMPLARY EMBODIMENTS OF THE PRESENT INVENTION

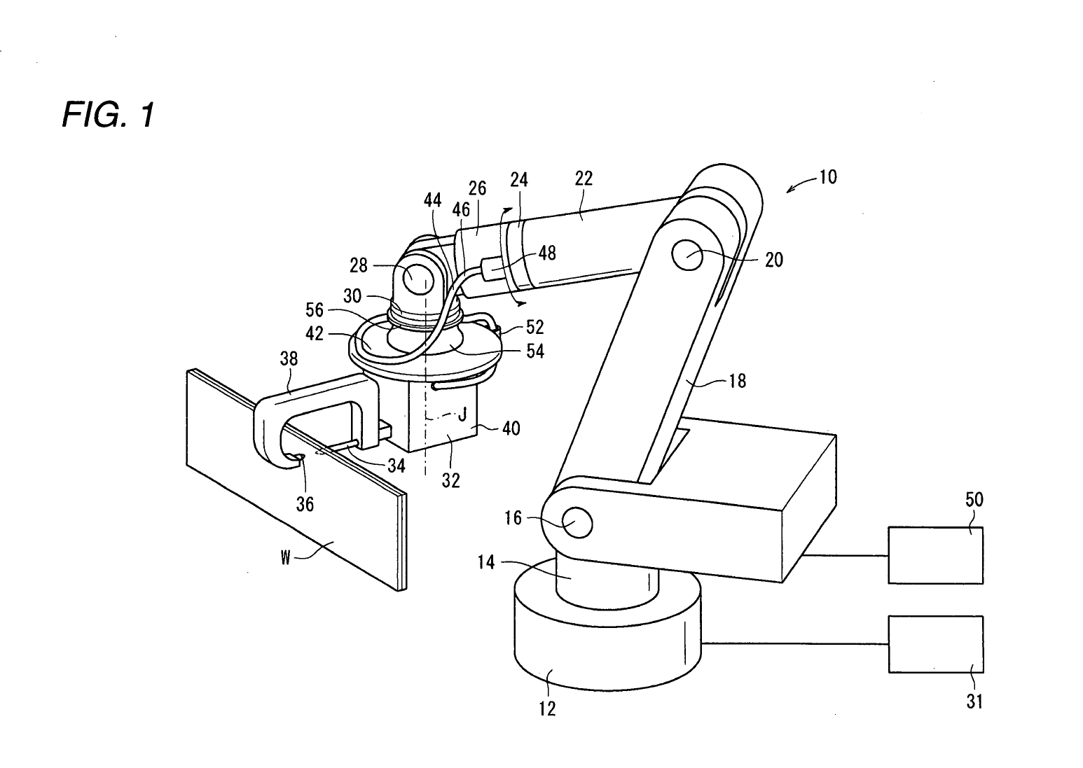

An articulated robot according to an exemplary embodiment of the present invention will be described below with reference to the accompanying drawings of FIG. 1 to FIG. 9.

The articulated robot 10 according to this embodiment is a so-called industrial robot that is used to make the spot welding for the work W, and applied to, for example, a process for manufacturing a frame for automobile, as shown in FIG. 1.

The articulated robot 10 has a first articulation 14, a second articulation 16, a third articulation 20, a fourth articulation 24, a fifth articulation 28 and a sixth articulation 30 with a base board 12 on the base end, and further has a welding gun 32, a flange 42 and a cable 44.

The first articulation 14 is rotated in horizontal plane with respect to the base board 12. The second articulation 16 is disposed near the first articulation 14, and revolved to tilt a first arm 18. The third articulation 20 is provided at the top of the first arm 18, and rotated to elevate a second arm 22. The fourth articulation 24 is provided between the second arm 22 and a third arm 26, which are coaxial, and rolls the third arm 26 around the second arm 22. The fifth articulation 28 is provided at the top of the third arm 26, and rotated to swing the sixth articulation (primary articulation) 30 of the top articulation. The sixth articulation 30 is disposed near the fifth articulation 28, and rolls the welding gun 32 that is a work machine (also called a tool or end effecter) around a roll axis J. The fourth articulation 24 and the sixth articulation 30 can be rolled by ±360°, that is, a total of 720° around the reference position. The fifth articulation 28 can be revolved by 260°.

In thus configured articulated robot 10 having six articulations which is independently operable, under program process of a controller, the welding gun 32 can be positioned at arbitrary position with arbitrary attitude relative to a work W.

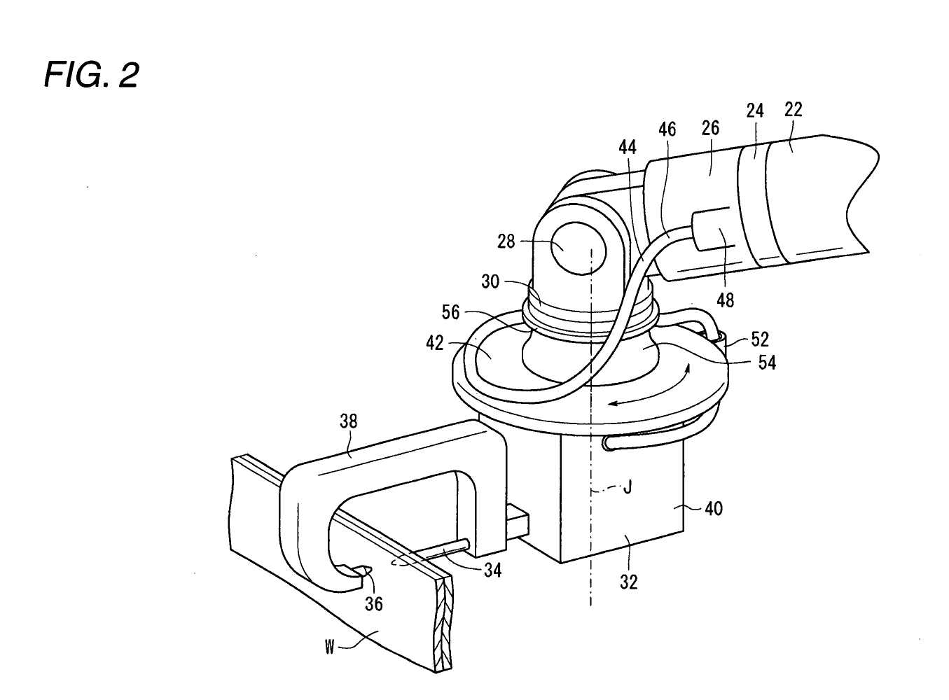

The welding gun 32 is a so-called C-type gun, and includes a C-shape member (action portion) 38 having a movable electrode 34 at one side and a fixed electrode 36 at the other side, and a control portion 40 for controlling the drive and current for the movable electrode 34, as shown in FIG. 2. The C-shape member 38, the fixed electrode 36 and the movable electrode 34 are the action portion for acting on the work W.

The control part 40 of the welding gun 32 is connected to the sixth articulation 30. The welding gun 32 can be removed. The welding gun 32 may be an X-shape gun or other work machines (e.g., paint spray gun).

A disk-like flange 42 extending in radial direction of the roll axis J is securely connected to a base end portion of the welding gun 32. The flange 42 is made of a resin material having adequate thickness and strength and has a simple constitution.

The welding gun 32 is supplied with power through the cable 44. The cable 44 has an inner electric wire (not shown) and a flexible protective tube 46 for covering the electric wire. The flexible protective tube 46 is made of a resin material or helically wounded metal material.

The cable 44 has one end connected to the welding gun 32, the other end being securely supported on a first support portion 48 provided on a side surface of the third arm 26 in the articulated robot 10. The cable 44 is connected via the first support portion 48 to a transformer 50 (see FIG. 1). The cable 44 may be disposed between the first support portion 48 and the transformer 50 through an inside or outside of the articulated robot 10.

The first support portion 48 is securely connected so that the cable 44 is substantially parallel to the axes of the second arm 22 and the third arm 26.

A second support portion 52 for supporting a part of the cable 44 in parallel to the roll axis J is provided in a part of the peripheral edge of the flange 42. The second support portion 52 is provided to guide the cable 44 from the front side of the flange 42 to the back side. In the second support portion 52, the cable 44 does not need to be accurately parallel to the roll axis J, but it is enough to be fixed to be substantially parallel. Thereby, the cable 44 can easily handle the forward or backward rotation of the roll axis J, and the turnover operation in the rotational direction, whereby torsion, bend or sudden collapse can be prevented.

The cable 44 does not need to be firmly fixed by the second support portion 52, but may be supported more or less tiltably.

The cable 44 is flexed to an extent not to produce an excessive tensile force between the second support portion 52 and a connection portion of the welding gun 32 and disposed in the almost shortest path. The cable 44 is provided with an adequate slack between the second support portion 52 and the first support portion 48, in which a slack part rides on the flange 42 and does not hang down loosely.

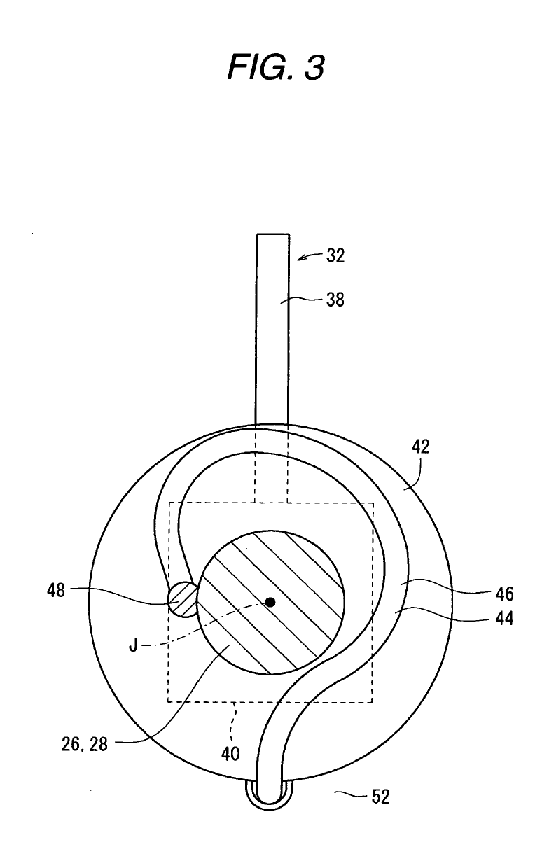

More specifically, when the fourth articulation 24 and the sixth articulation 30 are at the respective reference angles (center position in the range of rotation angle), when viewed from a direction of the roll axis J, as shown in FIG. 3, the first support portion 48 is disposed on the left side of the third arm 26, the cable 44 extends from the first support portion 48 as the point of origin to contact the left side of the upper surface of the flange 42, and is wound about 270° clockwise on the flange 42 to lead to the second support portion 52. The cable 44 is disposed to draw a gentle circular arc on the flange 42, with an adequate gap from the third arm 26 or the fifth articulation 28 secured.

Also, the second support portion 52 is provided on the opposite side of the C-shape member 38, when viewed from the roll axis J.

The flange 42 has an adequately large diameter and width, and covers almost all of the welding gun 32, with only the C-shape member 38 of the action portion exposed (that is, the radial dimension of the C-shape member 38 is larger than the that of the flange 42). Also, the first support portion 48 is included in this range. Thereby, the cable 44 is likely to get on the flange 42, and even if the cable hangs down from the periphery of the flange, the cable can be considerably prevented from contacting the welding gun 32.

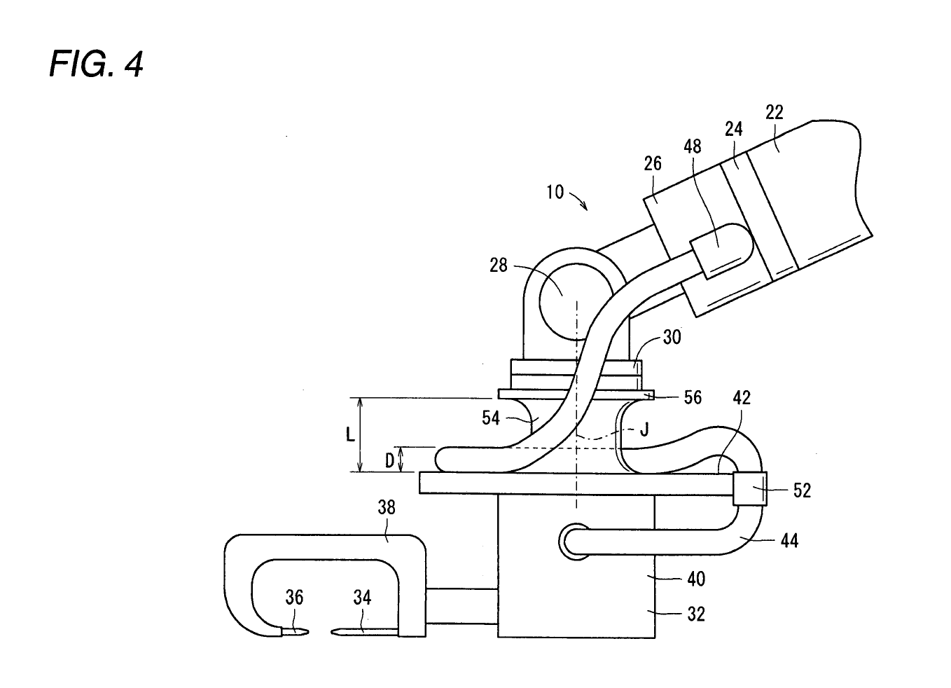

A cylindrical body 54 is provided between the flange 42 and the sixth articulation 30, as shown in FIG. 4. An auxiliary flange 56 substantially parallel to the flange 42 is provided on the base end side of the cylindrical body 54 from the flange 42 (on the side of the sixth articulation 30). The auxiliary flange 56 has a smaller diameter than the flange 42, and a slightly larger diameter than the sixth articulation 30 and the cylindrical body 54. The auxiliary flange 56 is fixed to the welding gun 32, together with the cylindrical body 54, but may be attached to the fifth articulation 28 or sixth articulation 30 under the design conditions.

The cylindrical body 54 is connected to one flange 42 and the other auxiliary flange 56 to form a smooth arc in side view, in which the flange 42, the auxiliary flange 56 and the cylindrical body 54 are a bobbin shape having a shallow annular concave portion. The height L of the cylindrical body 54 (i.e., distance between the flange 42 and the auxiliary flange 56) is slightly larger than double the diameter D of the cable 44. That is, a concave portion is formed along with the circumferential direction on an outer circumference of the cylindrical body 54.

The operation of the articulated robot 10 constituted in this way will be described below.

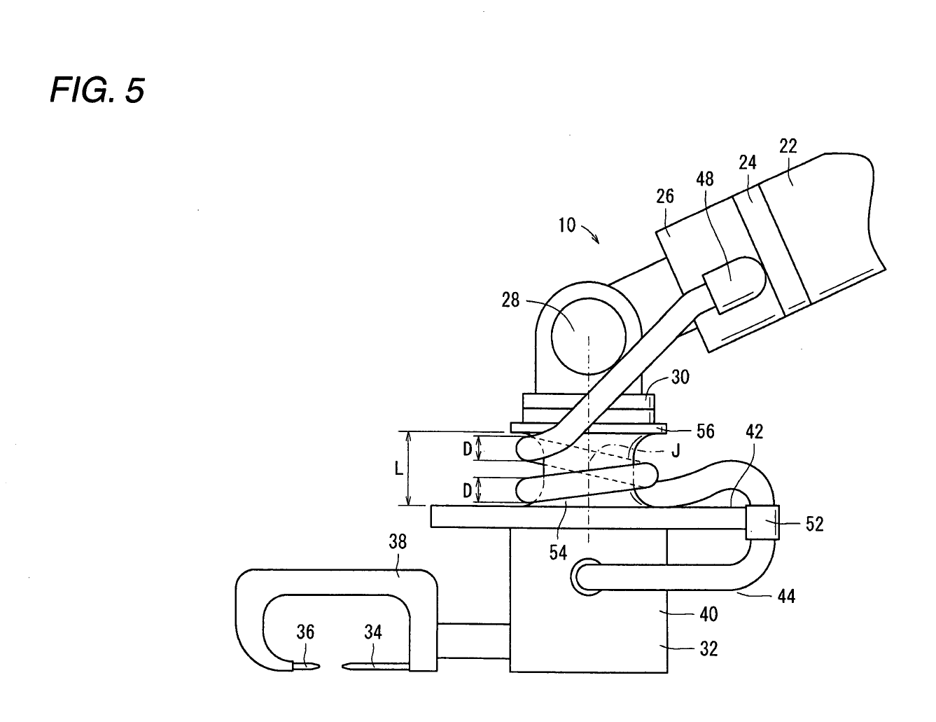

First of all, when the sixth articulation 30 is rotated by 360° in the counterclockwise direction from a state shown in FIG. 4, the cable 44 is wound once around the cylindrical body 54, as shown in FIG. 5. At this time, since the height L is slightly larger than double the diameter D, the cable 44 is aligned in two rows around the cylindrical body 54, and wound around the peripheral surface of the cylindrical body 54. Accordingly, the cable 44 is not wound in large diameter loosely, and the slack of the cable 44 at the reference time (see FIG. 4) is small.

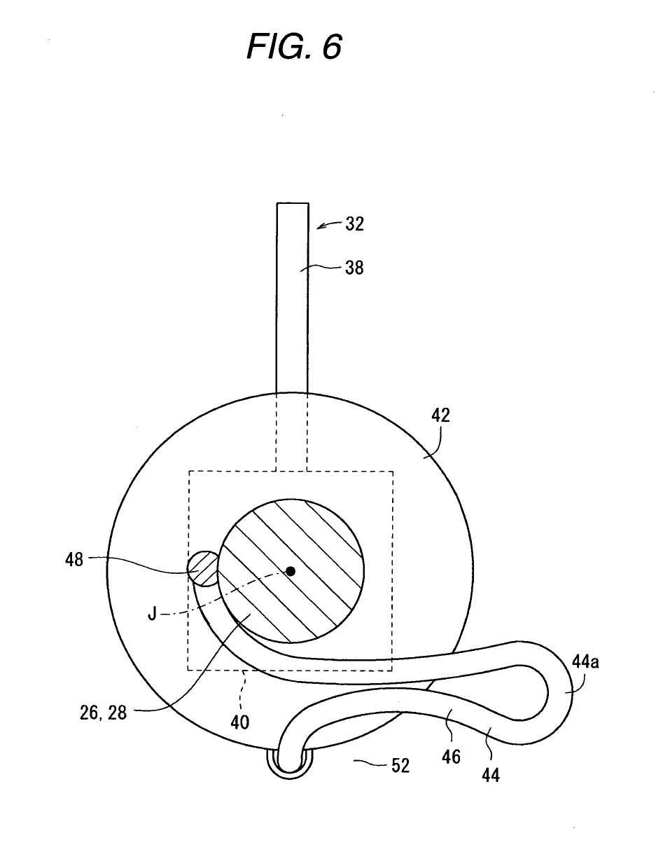

Then, when the sixth articulation 30 is rotated by 360° in the clockwise direction from the state shown in FIG. 4, the cable 44 protrudes in a part (indicated by reference sign 44a) from the flange 42 and slightly hangs down, as shown in FIG. 6. At this time, since the cable 44 has originally a small slack (see FIG. 4) and the flange 42 has an appropriately large diameter, the length of the part 44a protruding from the flange 42 is short. Also, the flange 42 covers almost all of the welding gun 32, when viewed from a direction of the roll axis J, whereby the possibility that the part 44a protruding from the flange 42 contacts with the welding gun 32, or the snagging (including bite, pinching and pulling) occurs is considerably low.

Particularly, since the second support portion 52 is provided on the opposite side of the C-shape member 38, the part 44a protruding from the flange 42 is also separated from the C-shape member 38, whereby the possibility that the part 44a contacts or catches the C-shape member 38 is low, as shown in FIG. 6. The state as shown in FIG. 6 is the state where the cable 44 has the largest slack.

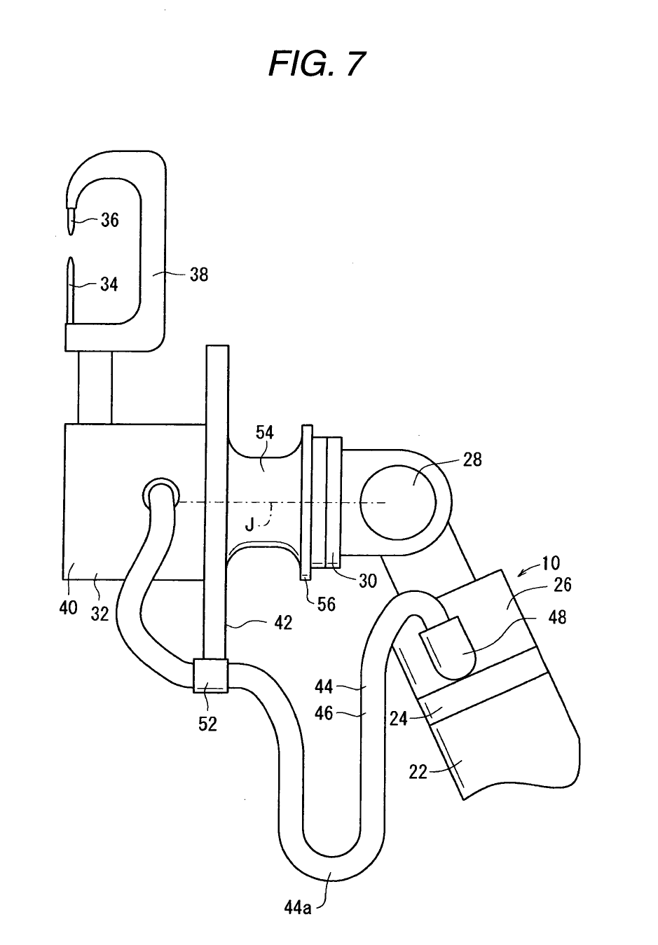

Then, if the welding gun 32 is tilted upward by 90° plus (the clockwise direction in FIGS. 7, 8 and 9 is defined as the plus direction, and the opposite is defined as the minus direction) from the state as shown in FIG. 6, a state as shown in FIG. 7 is produced. In this state, the slack part 44a of the cable 44 is placed at a lower position separated from the welding gun 32 and the C-shape member 38, in which the cable 44 does not contact or catch the welding gun 32.

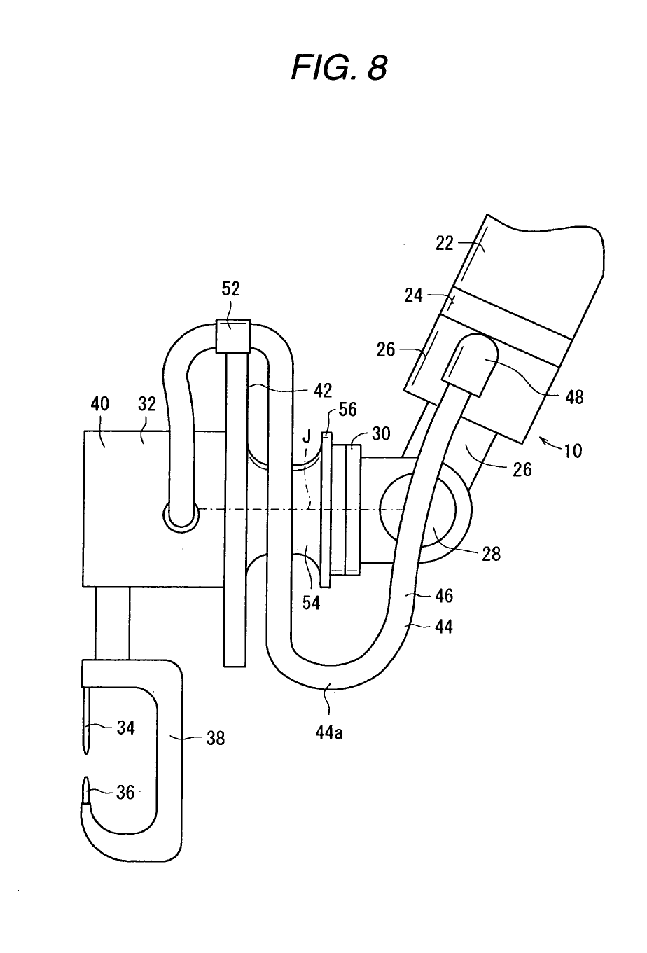

If the welding gun 32 is tilted downward by 90° minus from the state as shown in FIG. 6, a state as shown in FIG. 8 is produced. In this case, the second support portion 52 is located above the flange 42, and the cable 44 passes through this upper part, whereby the slack part 44a downward is small, and the flange 42 serves substantially as a shield between the part 44a and the C-shape member 38, whereby the cable 44 can be considerably prevented from contacting or catching the welding gun 32.

That is, since the second support portion 52 is provided at the opposite position of the C-shape member 38 acting on the work W in the welding gun 32, in plan view of the flange 42 (see FIG. 3), the cable 44 is always guided to the opposite position of the C-shape member 38, so that the slack part 44a is unlikely to contact the C-shape member 38. Though not shown, the same effect can be achieved when the welding gun 32 is oriented in the horizontal direction.

Since the second support portion 52 supports the cable 44 in parallel to the roll axis J, the cable 44 is guided in the direction away from the welding gun 32, whereby the cable 44 is oriented to the right on the base end side from the second support portion 52 and less likely to contact with the welding gun 32 on the left side in the state as shown in FIG. 8, for example. A part of the cable 44 between the second support portion 52 and the welding gun 32 has almost no slack, and the snagging does not occur.

In FIGS. 7 and 8, the orientation of the welding gun 32 is changed from the state (see FIG. 6) where the cable 44 has the largest slack. If the orientation of the welding gun 32 is changed from the state with the smaller slack (e.g., state as shown in FIG. 3), the cable 44 is of course less likely to contact or catch the welding gun 32 than in the state as shown in FIGS. 7 and 8.

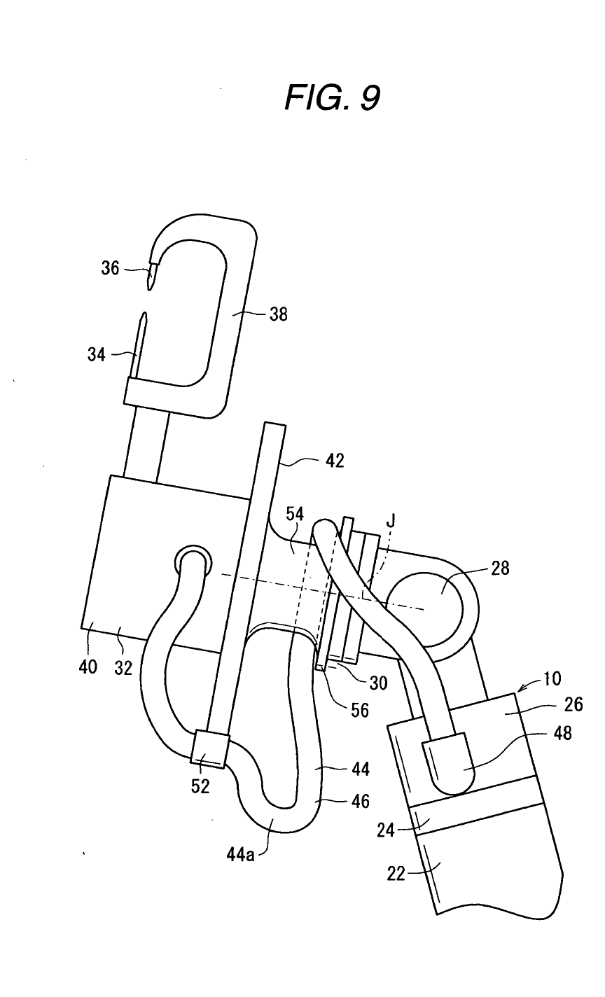

Then, if the welding gun 32 is tilted upward by about 100° plus from the state as shown in FIG. 4, a state as shown in FIG. 9 is produced. In this state, the cable 44 in the cylindrical body 54 slightly slides toward the base end side (side of the sixth articulation 30) but contacts with the auxiliary flange 56 and is held by a part of the bobbin shape, so that there is no further movement, with the remaining slack part 44a being small. Accordingly, the part 44a can be prevented from contacting the welding gun 32 or other portions (second arm 22 and so on).

As described above, with the articulated robot 10 according to this embodiment, because of provision of the flange 42, the cable 44 is less likely to contact the welding gun 32, even if the fifth articulation 28 or sixth articulation 30 ahead of the first support portion 48 is greatly operated, whereby the cable 44 can be considerably prevented from catching the welding gun 32 with a simple constitution.

Accordingly, the teaching and operation making effective use of the operable range of the fifth articulation 28 or sixth articulation 30 can be performed, whereby the working efficiency is improved.

The cable 44 is not necessarily limited to the power cable, but may be any other flexible cable (e.g., optical fiber, fluid pipe, and a complex thereof).

The articulated robot according to the invention is not limited to the above embodiment, but may adopt various other constitutions without departing from the spirit or scope of the invention.

What is claimed is:

1. An articulated robot comprising:
a plurality of articulations comprising at least a primary articulation capable of rolling around a roll axis;
a work machine connected to the primary articulation;
a flange which is provided between the primary articulation and the work machine, and extends in a radial direction of the roll axis of the primary articulation;
a cable having a part connected to the work machine and another part supported on a first support portion of the primary articulation with;
wherein a radial dimension of at least an extending part of the flange is larger than the radial dimension of the work machine, and
the cable is further supported on a second support portion formed on the extending part of the flange at a portion between the work machine and the first support portion of the primary articulation.

2. The articulated robot according to claim 1, wherein the second support portion supports the cable substantially in parallel to the roll axis.

3. The articulated robot according to claim 1, further comprising a cylindrical body provided between the flange and the primary articulation,
wherein a concave portion is formed on an outer circumference of the cylindrical body along with a circumferential direction of the cylindrical body.
